(19) United States
(12) Patent Application Publication
(10) Pub. No.: US 2006/0091162 A1
(43) Pub. Date: May 4, 2006

(54) Adjustable metered dosage particulate condiment dispenser

(75) Inventors: Chien-Gang Lin, Hong Kong (CN); Shi Peng, Hong Kong (CN)

Correspondence Address: Thomas E. Sisson;JACKSON WALKER L.L.P., Suite 2100, 112 E. Pecan Street, San Antonio, TX, 78205, US

(73) Assignee: Green Bow Limited

(21) Appl. No.: 10/981,025

(22) Filed: Nov. 4, 2004

(51) Int. Cl. G01F 11/10

(52) U.S. Cl. 222/361

(57) ABSTRACT

A dispenser for particulate material, includes a vessel for storing the particulate material, a dispensing head attached to or formed integrally with the vessel, the dispensing head having an port communicating with the vessel, a trigger movable with respect to the head and comprising a plurality of metering compartments that can be brought into alignment with the port upon depression of the trigger. The trigger has a number of steps formed thereon. A user-adjustable stopper is mounted upon the dispensing head and is configured to interact with the steps to selectively limit depression of the trigger to thereby align a selected one or more of said metering compartments with the port.

### BACKGROUND OF THE INVENTION

The present invention relates to condiment dispensers such as salt or pepper shakers. More particularly, although not exclusively, the invention relates to a salt shaker having a storage chamber, an adjustable metered dosage trigger and an arrangement by which excess/leaked salt particles are dispensed by the trigger.

Condiment dispensers for releasing metered particulate materials such as pepper, or herbs and spices are known. Such dispensers are not however known to comprise user-controlled auto-returning dispensing triggers for setting a required dosage of material to be dispensed. Furthermore, such dispensers are not designed with reduced friction, anti-clogging triggers, do not address the problem of excess material build-up around the trigger mechanism and are not airtight—thereby rendering their suitability for prolonged storage of absorptive material low.

### THE OBJECT OF THE INVENTION

It is the object of the present invention to address the above disadvantage and/or more generally to provide an improved particulate condiment dispenser providing user-adjustable metered dispensation of its contents.

### DISCLOSURE OF THE INVENTION

There is disclosed herein a dispenser for particulate material, comprising:

a vessel for storing the particulate material,

a dispensing head attached to or formed integrally with the vessel, the dispensing head having a port communicating with the vessel,

a trigger movable with respect to the dispensing head and comprising a plurality of metering compartments that can be brought into alignment with the port upon depression of the trigger, the trigger having a number of steps formed thereon, and

a user-adjustable stopper mounted upon the dispensing head and configured to interact with the steps to selectively limit depression of the trigger to thereby align a selected one or more of said metering compartments with the port.

Preferably, the dispensing head further comprises a dispensing path via which any excess particulate material can be dispensed.

Preferably, the trigger is mounted to the dispensing head so as to slide linearly therein.

Preferably, the dispensing head comprises a pair of posts onto which a pair of springs are mounted, the springs biasing the trigger into a rest position.

Preferably, the dispensing head comprises a pair of fixed trigger guides, and the trigger has a pair of curved side faces that slide along the respective trigger guides.

Preferably, the dispensing path includes spaces alongside the curved side faces.

Preferably, the dispenser further comprises a separator board positioned beneath the trigger and comprising a main dispensing aperture to be aligned with the metering compartments and a pair of side dispensing apertures laterally flanking the trigger and aligned with the dispensing path spaces, and a rear dispensing aperture aligned with the dispensing chamber.

Preferably, the trigger rests in a retracted position making it possible to fit a cap upon the dispensing head and thereby conceal any openings in the dispensing head through which moist air might pass.

### BRIEF DESCRIPTION OF THE DRAWINGS

A preferred form of the present invention will now be described by way of example with reference to the accompanying drawings, wherein:

FIG. 1 is a schematic parts-exploded perspective illustration of an adjustable metered dosage particulate condiment dispenser,

FIG. 2 is a schematic inverted perspective illustration of the dispensing head of the dispenser,

FIG. 3 is a schematic perspective illustration of the dispensing head with internal components removed for illustration purposes,

FIG. 4 is a schematic inverted plan view of the dispensing head of FIG. 3,

FIG. 5 is a schematic cross-sectional elevation of the dispensing head,

FIG. 6 is a schematic plan view of the dispensing head with parts installed therein,

FIG. 7 is a schematic side elevation of a trigger-return spring,

FIG. 8 is a schematic plan illustration of the trigger-return spring,

FIG. 9 is a schematic perspective illustration of the trigger,

FIG. 10 is a schematic cross-sectional elevation of the trigger,

FIG. 11 is the a plan view of the trigger, and

FIG. 12 is a schematic perspective illustration of a separator board.

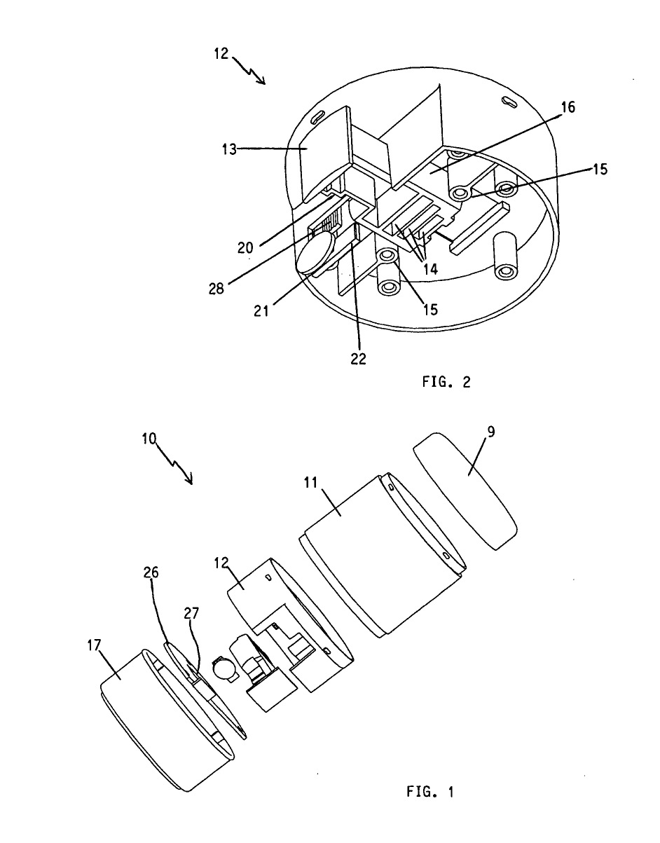

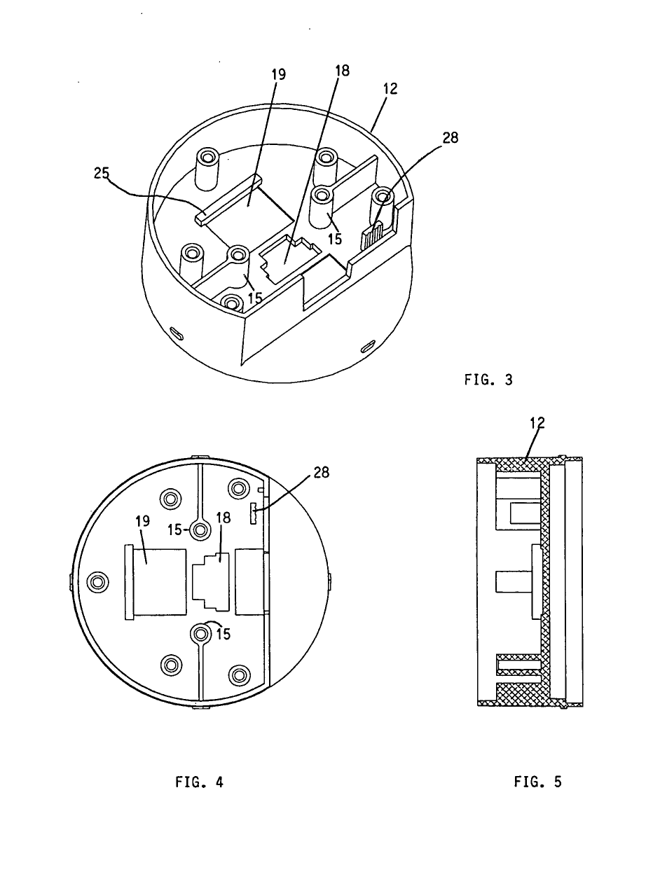

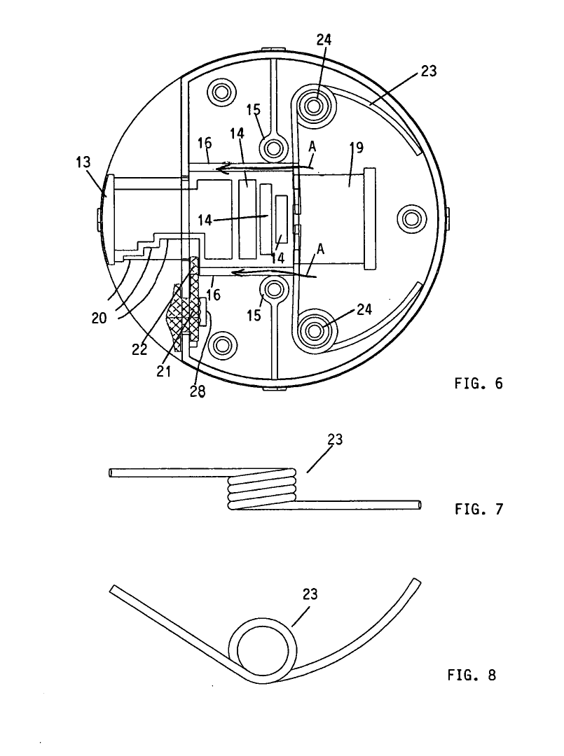

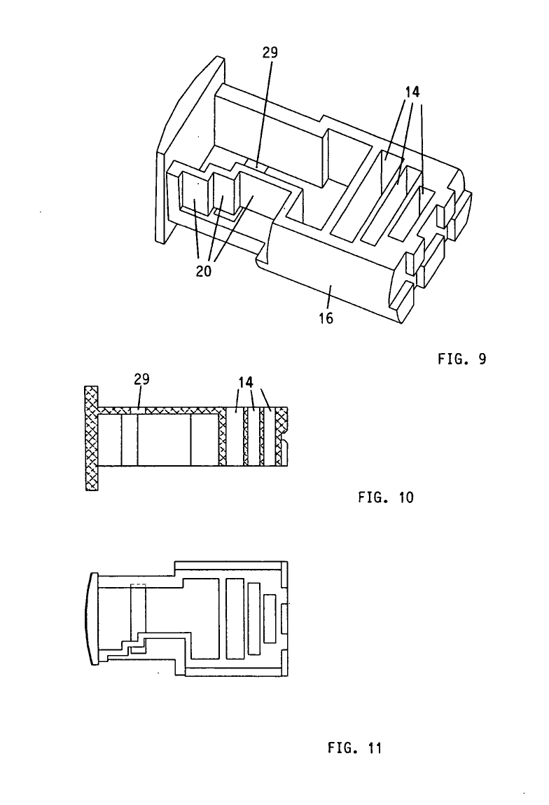

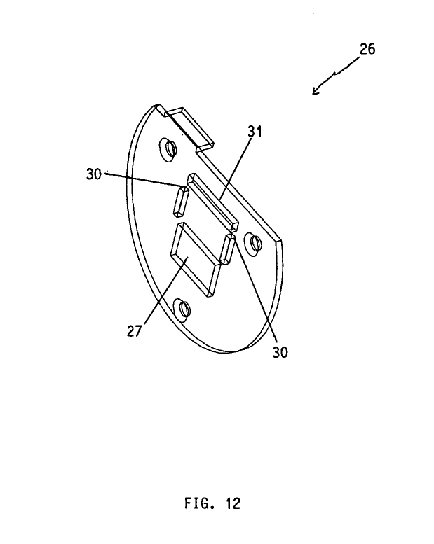

### DESCRIPTION OF THE PREFERRED EMBODIMENT

In the accompanying drawings there is depicted schematically a metered dosage particulate condiment dispenser 10 hereinafter referred to as a salt shaker.

The salt shaker 10 comprises a vessel 11 having a lid 9 attached removably at one end thereof and a dispensing head 12 attached removably at the other.

The dispensing head, which is typically fabricated as a moulded plastics component, comprises a step-shaped port 18 and a pair of guide pins 15 flanking the port 18. A trigger 13 has a pair of opposed curved side faces 16. The side faces bear against the guide pins 15 with sliding point contact dividing low sliding friction. That is, only the longitudinal centreline of each side face 16 engages with the inward facing vertical edges of the guide pins 15 as the trigger slides in and out.

The dispensing head of the salt shaker also includes a sink area 19 to reduce fictional contact between the trigger 13 and dispensing head 12. A stopper block 25 is formed integrally with the dispensing head 12 and provides a buffer against which the back end of the trigger bears to define its maximum depression position. As the trigger collides with this block, a shake effect insures complete dropout of the particulate material for dispensation.

The trigger 13 includes a number of metering compartments 14 ranging from small to large and extending from top to bottom through the trigger. The small metering compartment might correspond in volume to a “pinch of salt”, whereas the larger metering compartments (in combination with the smaller ones) might correspond in volume with a “teaspoon of salt” for example.

A pair of torsion spring 23 mounted upon respective spring posts 24 biases the trigger 13 forward. These torsion springs have tails as depicted engaging cuttings of the trigger. The use of torsion springs (as against compression coil springs for example) has the benefit of reducing spring operational noise, enabling longer distance travel of the trigger with only a small space required for the springs, and increased durability and repeated operability.

Near the front of the trigger 13 there is provided a plurality of steps 20. Alongside the steps and fixed firmly upon the head by a stopper guide 28 having high-friction serrations is a stopper 21 having a stopper pin 22. The user can slide the stopper 21 (against the holding friction of the serrations) to a selected position so that the stopper pin bears against a selected one of the steps 20 when the trigger is depressed. The dispensing head would be provided with markings (say “S” for Small, “M” for Medium and “L” for Large) alongside the stopper 21 so that the desired position can be set by the user.

A separator board 26 having a main dispensing aperture 27 is located between the cap 17 and the dispensing head 12. Metered dispensation of particulate material from one or more of the metering compartments occurs via the main dispensing aperture 27 as the compartments 14 are brought into alignment therewith upon depression of the trigger. The trigger also includes a dispensing chamber 29 extending from the top to the bottom of the trigger.

A rear dispensing aperture 31 is aligned with the dispensing chamber 29 and a pair of side dispensing apertures 30 laterally flank the trigger. As a result of repeated depression of the trigger 13, some salt (or other particulate condiment as the case may be) will escape around the trigger. To prevent the possibility of this escaped material from clogging the mechanism to the point that the trigger might be jammed by a build-up of the material, the curved nature of the faces 16 and the point contact made between these faces and the trigger guides 15 provides flow passages as indicated by arrows A in FIG. 6 to allow any such material to migrate along flow paths away from the sink area 19 from which it can then flow via the spaces alongside each curved wall 16 (upon repeated depression of the trigger) toward the side apertures 30 through which it is dispensed. Further, material that has escaped on top of the trigger can be dispensed through the dispensing chamber 29 of the trigger via the rear dispensing aperture 31.

A cap 17 is fitted upon the dispenser head 12 to prevent the unwanted ingress of humidity therepast to the vessel 11. This might be particularly useful where the dispenser is used to store salt, sugar or coffee grounds for example. The trigger is so configured with respect to the dispensing head that the trigger rests in a retracted position making it possible to fit a cap upon the dispensing head and thereby conceal the trigger and any openings in the dispensing head through which moist air might pass.

It should be appreciated that modifications and alterations obvious to those skilled in the art are not to be considered as beyond the scope of the present invention. For example, rather than providing curved faces 16 to provide point contact upon vertical guides 15, the opposed faces of the trigger might be flat angled surfaces, or simply be shaped with a longitudinal slot providing flow paths (arrows A) for excess/leaked particulate material toward the side dispensing apertures 30. Furthermore, the flat wall through which the trigger 13 extends could be curved in continuous alignment with the curved frontage of the trigger 13 if desired. Also, apart from use in storing and dispensing salt and other condiments, the dispenser could be used to store in an airtight manner coffee, sugar, protein powder, powdered milk, medicines and any other bulk flowable/particulate material.

1. A dispenser for particulate material, comprising:
a vessel for storing the particulate material,
a dispensing head attached to or formed integrally with the vessel, the dispensing head having a port communicating with the vessel,
a trigger movable with respect to the dispensing head and comprising a plurality of metering compartments that can be brought into alignment with the port upon depression of the trigger, the trigger having a number of steps formed thereon, and
a user-adjustable stopper mounted upon the dispensing head and configured to interact with the steps to selectively limit depression of the trigger to thereby align a selected one or more of said metering compartments with the port.

2. The dispenser of claim 1, wherein the dispensing head further comprises a dispensing path via which any excess particulate material can be dispensed.

3. The dispenser of claim 1, wherein the trigger is mounted to the dispensing head so as to slide linearly therein.

4. The dispenser of claim 2, wherein the dispensing head comprises a pair of fixed trigger guides, and the trigger has a pair of curved side faces that slide along the respective trigger guides.

5. The dispenser of claim 4, wherein the dispensing path includes spaces alongside the curved side faces.

6. The dispenser of claim 5, further comprising a separator board positioned beneath the trigger and comprising a main dispensing aperture to be aligned with the metering compartments and a pair of side dispensing apertures laterally flanking the trigger and aligned with the dispensing path spaces, and a rear dispensing aperture aligned with the dispensing chamber.

7. The dispenser of claim 3, wherein the dispensing head comprises a pair of posts onto which a pair of torsion springs are mounted, the springs biasing the trigger into a rest position.

8. The dispenser of claim 1, wherein the trigger rests in a retracted position making it possible to fit a cap upon the dispensing head and thereby conceal any openings in the dispensing head through which moist air might pass.

9. The dispenser of claim 1, further comprising a cap fitted upon the dispensing head.
